(19) United States
(12) Patent Application Publication
(10) Pub. No.: US 2026/0260459 A1
(43) Pub. Date: Sep. 3, 2026

(54) QUANTITATIVE ANALYSIS METHOD FOR SPATIAL ELEMENTS IN HIGH-INTENSITY URBAN AREAS BASED ON IMAGE DATA

(71) Applicant: Beijing University of Civil Engineering and Architecture, Beijing (CN)

(72) Inventors: Yuefang Rong, Beijing (CN); Yue Hu, Beijing (CN); Haoxi Lin, Beijing (CN); Mengyuan Jia, Beijing (CN); Xin Yan, Beijing (CN); Jian Song, Beijing (CN); Siwei Guo, Beijing (CN); Haoran Zhang, Beijing (CN); Yunqian Chen, Beijing (CN); Jijia Jiang, Beijing (CN); Zheng Ma, Beijing (CN); Xinxin Liu, Beijing (CN); Zilin Wang, Beijing (CN); Xiaohang Liang, Beijing (CN); Shuhan Guo, Beijing (CN)

(21) Appl. No.: 19/237,034

(22) Filed: Jun. 13, 2025

(30) Foreign Application Priority Data
Feb. 28, 2025 (CN) 202510234418.7

(51) Int. Cl. G06V 10/764; G06T 5/70; G06T 7/13; G06V 10/426; G06V 10/54; G06V 10/56; G06V 10/80

(52) U.S. Cl. CPC G06V 10/764; G06T 5/70; G06T 7/13; G06V 10/426; G06V 10/54; G06V 10/56; G06V 10/806; G06T 2207/20182; G06T 2207/20192

(57) ABSTRACT

A quantitative analysis method for spatial elements in high-intensity urban areas based on image data includes: obtaining a panoramic street view image from observation points in a selected high-intensity urban area; extracting, based on vision inspection technology, shallow features from the panoramic street view image; obtaining deep features in the panoramic street view image through a deep learning model; constructing, based on topological analysis, a topological graph of the spatial elements by registering each shallow and deep feature with predefined logical rules; and inputting the topological graph to a classification model which is pre-trained, and outputting, by the classification model, classification results and a spatial distribution image of the spatial elements in the panoramic street view image. The method achieves multi-dimensional feature fusion by simultaneously utilizing the shallow and deep features, which improves the accuracy of classification and enhances the adaptability to multi category elements in complex scenes.

### TECHNICAL FIELD

The disclosure relates to the field of image element recognition technologies, and more particularly to a quantitative analysis method for spatial elements in high-intensity urban areas based on image data.

### BACKGROUND

With the rapid development of computer technologies, the classification of spatial elements in urban area images has gradually shifted from manual interpretation to automated processing. At the current stage, automated classification methods based on image processing technology have become increasingly diverse, mainly including supervised classification, unsupervised classification, and object-oriented classification.

Specifically, the supervised classification relies on high-quality pre-labeled samples, by learning from known samples to guide the classification model in classifying elements in unknown areas. However, the results of the supervised classification are highly dependent on the representativeness and accuracy of the samples. When the number of the samples is insufficient or the labeling quality is poor, the classification accuracy may significantly decrease, leading to classification bias. The unsupervised classification, on the other hand, automatically performs clustering on image pixels through an algorithm without the need for pre-labeled samples. However, the unsupervised classification requires high computational resources, which limits its application efficiency in large-scale urban area image processing.

The object-oriented classification is a method based on image segmentation, including: dividing an image into a series of homogeneous small areas (i.e., “objects”) and then classifying these objects. This method can effectively combine spectral information with geometric information, but the classification results are easily affected by the quality of an image segmentation algorithm. Over-segmentation or under-segmentation can directly impact the final classification accuracy, causing the classification results to deviate from the actual situation.

By contrast, classification methods based on deep learning can deeply explore deep features in the image and have shown significant advantages in the classification of urban area images. Through multi-scale feature extraction and context information fusion technology, deep learning models can effectively distinguish between buildings, vegetation, roads, and other spatial elements in complex scenes. However, deep learning methods mainly focus on the deep exploration of features of the spatial elements themselves and are insufficient in utilizing the association knowledge between elements and specific recognition features, which, in scenes with mixed multiple elements, may easily lead to low classification accuracy and inconsistent classification results.

### SUMMARY

Technical problems to be solved is as follows. The disclosure provides a quantitative analysis method for spatial elements in high-intensity urban areas based on image data, which can solve the problems of poor classification accuracy of classification results and inconsistent classification results in scenes with mixed multiple factors.

Technical solutions are as follows.

In order to achieve the above purposes, the disclosure provides the following technical solutions. The quantitative analysis method, executable by one or more processors, includes following steps:
obtaining a panoramic street view image from observation points in a selected high-intensity urban area;
extracting, based on edge detection, color analysis and texture analysis, shallow features from the panoramic street view image, and preliminarily identifying, by combining predefined shallow feature templates, spatial elements in the panoramic street view image;
obtaining deep features for each of the spatial elements through a deep learning model, wherein the deep features comprise a geometric shape and a spatial position of each of the spatial elements, and semantic association relationships between the spatial elements;
constructing, based on topological analysis, a topological graph of the spatial elements, and optimizing, according to predefined logical rules, a topological structure of the topological graph to obtain an optimized topological graph, where each of nodes in the topological graph represents a corresponding one of the spatial elements and carries the shallow features and the deep features of the corresponding one of the spatial elements, edges between the nodes represent the semantic association relationships between the spatial elements respectively; and
inputting the optimized topological graph into a pre-trained classification model, and outputting, by the pre-trained classification model, classification results and a spatial distribution image of the spatial elements in the panoramic street view image based on node features and a topological structure of the optimized topological graph.

In an embodiment, the quantitative analysis method further includes: determining, based on the classification results and the spatial distribution image of the spatial elements, distribution ratios and densities of the spatial elements within the high-intensity urban areas to obtain a spatial utilization rate, where the spatial utilization rate includes: a building coverage ratio, a green space coverage ratio, a transportation land ratio, and a public service facilities land ratio; and when any one of the following is not met: the building coverage ratio in a range of 40%-60%, the green space coverage ratio greater than 20%, the transportation land ratio in a range of 15%-25%, and the public the service facilities land ratio in a range of 5%-15%, optimizing urban area planing accordingly.

Specifically, the building coverage ratio is a proportion of the area occupied by “buildings” in the classification results to a total land area (i.e., the total area of the selected high-intensity urban area observation points). The green space coverage ratio is proportion of the area occupied by “green spaces” in the classification results to the total land area. The transportation land ratio is a proportion of the area occupied by transportation land, such as “roads”, “parking lots”, and “sidewalks”, in the classification results to the total land area. The public service facilities land ratio is a proportion of the area occupied by public service facilities land, such as “squares”, in the classification results to the total land area.

In an embodiment, before the extracting, based on edge detection, color analysis and texture analysis, shallow features from the panoramic street view image, the quantitative analysis method includes: performing image preprocessing on the panoramic street view image. The image preprocessing includes: noise removal, image enhancement, and image segmentation, specifically including:
removing random noise from the panoramic street view image, and preserving edge information in the panoramic street view image to obtain a noise-removed panoramic street view image; and
performing brightness and contrast analysis on the noise-removed panoramic street view image, performing histogram equalization on local areas of the noise-removed panoramic street view image, and performing contrast enhancement on low-contrast areas (i.e., the target area) of the noise-removed panoramic street view image.

In an embodiment, the extracting, based on edge detection, color analysis and texture analysis, shallow features from the panoramic street view image includes:
performing Canny edge detection on the panoramic street view image, including: locating, by calculating a grayscale change intensity and using gradient information, boundaries of objects in the panoramic street view image;
extracting, through a hue-saturation-value (HSV) color space, color distribution features of each of the objects; and
extracting, by using a gray-level co-occurrence matrix, surface texture information of each of the objects.

In an embodiment, the preliminarily identifying, by combining predefined shallow feature templates, spatial elements in the panoramic street view image includes:
matching the objects in the panoramic street view image and the shallow features thereof with the predefined shallow feature templates to preliminarily identify, through a matching algorithm, the spatial elements represented by the objects respectively.

In an embodiment, the obtaining deep features for each of the spatial elements through a deep learning model includes:
obtaining, through a deep learning-based semantic segmentation model, the deep features for each of the spatial elements, where the deep features further include relative distances between the spatial elements.

In an embodiment, the predefined logical rules include:
adjusting, based on the geometric shape and the spatial position of each of the spatial elements and the relative distances between the spatial elements, a weight of each of the edges, including:
   calculating projection distances between the spatial elements, setting a distance threshold, and adjusting the weight of each of the edges proportionally; and
adjusting, based on the semantic association relationships between the spatial elements, the weight of each of the edges, including:
   in response to two of the spatial elements having a functional association in a real scene, increasing the weight of the edge between the nodes represented by the two of the spatial elements;
   in response to two of the spatial elements having no functional association, deleting the edge between the nodes represented by the two of the spatial elements.

In an embodiment, the optimizing, according to predefined logical rules, a topological structure of the topological graph to obtain an optimized topological graph includes:
updating, according to the predefined logical rules, the weight of each of the edges, and performing a graph convolution operation to optimize the node features and spatial distribution in the topological graph.

In an embodiment, the pre-trained classification model is configured to perform classification on the spatial elements in the panoramic street view image based on a deep learning technology. A training process of the pre-trained classification model includes:
inputting the optimized topological graph, and generating a feature vector corresponding to each of the nodes based on the shallow features and the deep features of each of the nodes;
aggregating, through a message-passing mechanism and according to adjacency relationships and weights of edges corresponding to a target node to be recognized, features of neighboring nodes of the target node to obtain aggregated features of the neighboring nodes, and fusing the aggregated features of the neighboring nodes with current features of the target node to generate target node features including contextual information; and
inputting the feature vector corresponding to each of the nodes to a defined classifier to output the classification result for each of the spatial elements, and generate the spatial distribution image of the spatial elements in the panoramic street view image by combining the classification results of the spatial elements and spatial position relationships in the topological graph.

In an exemplary embodiment, each of the deep learning model, the pre-trained classification model, and the deep learning-based semantic segmentation model is embodied by at least one processor and at least one memory coupled to the at least one processor, and the at least one memory stores computer programs executable by the at least one processor.

Beneficial effects are as follows.

Compared to the related art, the embodiments of the disclosure may have following beneficial effects.

The quantitative analysis method of the disclosure includes: preliminarily determining the spatial elements in the image by jointly extracting the shallow and deep features from the panoramic street view image, constructing the topological graph of the spatial elements, and adjusting the weights of the edges in the topological graph according to the predefined logical rules to enhance the model adaptability to the complex correlation relationships among spatial elements in actual street-view scenes; and thus is applicable to the complex and diverse spatial structures in the high-intensity urban area.

By using the pre-trained deep learning based classification model, the features of the spatial elements and their topological relationships are combined, and the expression of the node features are optimized through the message-passing mechanism utilizing the features and weights of adjacent nodes, making the classification model can effectively capture the contextual information, thereby enhancing the reliability and precision of classification results. Ultimately, the combination of the classification results and the spatial distribution image are output and provides an intuitive display of the distribution of each spatial element.

### BRIEF DESCRIPTION OF DRAWINGS

FIG. 1 illustrates a flowchart of a quantitative analysis method for spatial elements in high-intensity urban areas based on image data according to an embodiment of the disclosure.

FIG. 2 illustrates a schematic diagram of various target-recognized spatial elements in the high-intensity urban areas in the quantitative analysis method according to the embodiment of the disclosure.

FIG. 3 illustrates a schematic diagram of a topological graph of various spatial elements in an image constructed by using topology technology in the quantitative analysis method according to the embodiment of the disclosure.

FIG. 4 illustrates a schematic diagram of the topological graph optimized based on predefined logical rules in the quantitative analysis method according to the embodiment of the disclosure.

### DETAILED DESCRIPTION OF EMBODIMENTS

Technical solutions in embodiments of the disclosure will be clearly and completely described in conjunction with the accompanying drawings. Apparently, the described embodiments are only a part of the embodiments of the disclosure, not all of them. Based on the embodiments of the disclosure, all other embodiments obtained by those skilled in the art without creative labor are within the scope of protection of the disclosure.

In the description of the disclosure, it should be understood that terms “longitudinal”, “transverse”, “length”, “width”, “thickness”, “up”, “down”, “front”, “rear”, “left”, “right”, “vertical”, “horizontal”, “top”, “bottom”, “inside”, “outside” and other directional or positional relationships indicated are based on directional or positional relationships shown in the accompanying drawings, only for the convenience of describing the disclosure and simplifying the description, and do not indicate or imply that the device or element referred to must have a specific orientation, be constructed and operated in a specific orientation, and therefore cannot be understood as a limitation of the disclosure.

Additionally, if the terms “first” and “second”, etc. appear, they are only used to distinguish descriptions and cannot be understood as indicating or implying relative importance.

It should be noted that the features in the embodiments of the disclosure can be combined with each other in the case of no conflict.

With the rapid development of computer technologies, the classification of spatial elements in urban area images has gradually shifted from manual interpretation to automated processing. Automated classification methods based on image processing technology have become increasingly diverse, mainly including supervised classification, unsupervised classification, and object-oriented classification. These methods have their own characteristics in practical applications

Specifically, the supervised classification is currently one of the widely used methods and relies on high-quality pre-labeled samples, that is, by learning from known samples to guide a classification model in classifying elements in unknown areas. However, the results of the supervised classification are highly dependent on the representativeness and accuracy of the samples, which is prone to cause classification bias when the number of the samples is insufficient or the labeling quality is poor.

The unsupervised classification, automatically perform clustering on image pixels through an algorithm without the need for pre-labeled samples, and is a relatively independent classification method. However, the unsupervised classification algorithm needs to set the number of categories in advance, which depends heavily on the clustering quality of the results. In addition, since the unsupervised classification has a complex calculation process and a low convergence speed, and the computer operation time is long, the application efficiency of the unsupervised classification in large-scale urban area image processing is limited.

In addition to the two classification methods mentioned above, the object-oriented classification is a commonly used method based on image segmentation, including: dividing an image into a series of homogeneous small areas (i.e., “objects”) and then classifying these objects. This method can effectively combine spectral information with geometric information, but the classification results are easily affected by the quality of an image segmentation algorithm. Over-segmentation or under-segmentation of images can directly impact the final classification accuracy, causing the classification results to deviate from the actual situation. Therefore, the object-oriented classification is also not suitable for large-scale urban area image processing.

With the rapid development of the artificial intelligence (AI), in the classification of spatial elements in urban area images, traditional image processing technologies have been gradually replaced by machine learning methods.

Specifically, traditional machine learning methods mainly employ algorithms such as decision trees, random forests, or maximum likelihood methods. These methods primarily rely on shallow features of images, that is, they use directly observable features such as the color, texture, and shape of areas in the images to complete classification. However, these methods have limitations in the extraction and utilization of deep features in the images, leading to insufficient adaptability of classification results to complex scenes, especially when there are fuzzy boundaries or complex relationships between the spatial elements.

By contrast, classification methods based on deep learning can deeply explore the deep features in images and have been widely used in the classification of urban area images in recent years. By constructing multi-layer network structures, the deep learning can analyze high-level semantic information of images, thereby significantly improving classification accuracy. Specifically, network architectures such as U-Net, pyramid scene parsing network (PSP Net), and DeepLabv3+ have been extensively utilized for the classification of the spatial elements. Through techniques like multi-scale feature extraction and contextual information fusion, they can effectively distinguish between elements such as buildings, vegetation, and roads in the complex scenes. However, the deep learning methods primarily focus on the deep exploration of the features of the elements themselves and lack the utilization of the associative knowledge between specific elements and their particular identification features. This may result in insufficient interpretability and consistency of classification results in scenes with mixed multiple elements.

In summary, the evolution of spatial element classification techniques in urban area images from traditional image processing to AI methods significantly enhances the degree of automation and accuracy of classification. However, different limitations and challenges still exist in various methods, and how to further improve classification efficiency, accuracy, and applicability remains an important direction for current research.

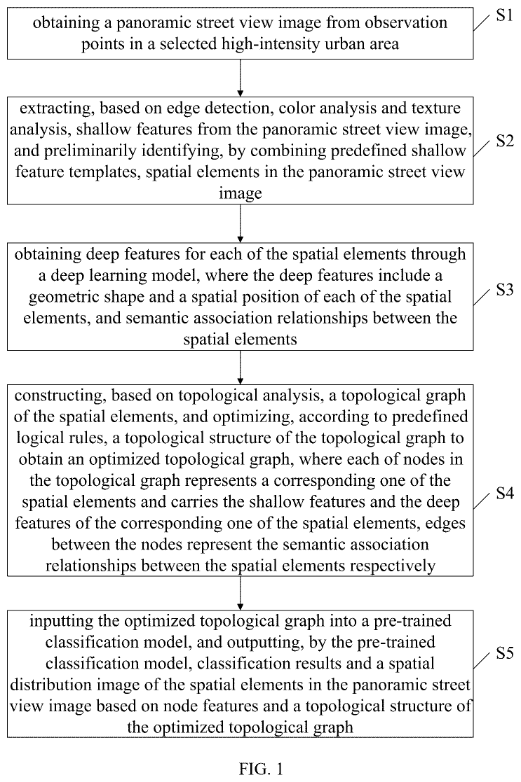

In order to solve above problems, the disclosure provides a quantitative analysis method for spatial elements in high-intensity urban areas based on image data, as shown in FIGS. 1-4. The quantitative analysis method not only improve the accuracy and efficiency of spatial element quantitative analysis in the high-intensity urban areas, but also has strong applicability and scalability, providing more intelligent technical support for urban planning and management.

Specifically, firstly step S1 is performed as follows: obtaining a panoramic street view image from observation points in a selected high-intensity urban area.

The observation points are selected based on characteristics of the high-intensity urban areas such as high building density, large population density, and high traffic volume etc., in conjunction with factors as follows.

Geographical location distribution: for example, representative areas such as commercial districts, transportation hubs, and densely populated residential areas are selected.

Scene coverage: the observation points should be evenly distributed to ensure that the panoramic street view images cover the main roads, squares, and key facilities within the areas.

Functional requirements: depending on specific analysis needs, areas that can comprehensively reflect various spatial elements such as buildings, roads, vegetation, and streetlights should be selected.

For example, in a commercial center of a city, entrances and exits of subway stations, intersections of main roads, and commercial squares are chosen as the observation points to ensure coverage of areas with high pedestrian density and key transportation nodes, and to obtain the panoramic street view images correspondingly.

Image preprocessing is performed before the extracting, based on edge detection, color analysis and texture analysis, shallow features from the panoramic street view image.

Specifically, random noise (such as Gaussian noise and salt and pepper noise) is removed from the panoramic street view image with edge information in the panoramic street view image preserved to obtain a noise-removed panoramic street view image, thereby avoiding affecting the accuracy of subsequent feature extraction. In some embodiments of the disclosure, by calculating image local similarity, noise is removed based on a weighted average method, while preserving edge and texture information.

For example, for the panoramic street view image of the commercial center mentioned above, non-local-means filtering is applied. After noise removal, the clarity of the edge areas is improved, thereby preserving main details of building contours.

Image enhancement operations aim to improve brightness, contrast and visual clarity of images, and enhance the visibility of areas with low illumination or low local contrast, thereby providing higher quality input for subsequent feature extraction. In some embodiments of the disclosure, global histogram equalization is applied to the entire image to redistribute gray levels and enhance image contrast, particularly the details in highlights and shadows. Alternatively, adaptive histogram equalization can be used to process local areas of the image, avoiding over-enhancement that may result from global equalization. For areas in the street view image affected by shadows, Gamma correction is used to adjust the brightness. Laplacian filtering or high-pass filtering is then applied to the enhanced image to highlight edge features, increasing the clarity of structures such as building contours and road boundaries.

For example, after applying contrast limited adaptive histogram equalization (CLAHE) to the panoramic street view image along a certain road, previously unclear streetlights and signs in the shadows become visible, with improved contrast, providing more usable information for input into the classification model.

In some embodiments of the disclosure, the panoramic street view image after noise filtering and enhancement is divided into multiple small segments to ensure that each segment contains local information, which facilitates subsequent feature extraction and classification analysis of specific spatial elements. Specifically, a grid division method can be used to cut the panoramic street view image into multiple small segments according to a fixed size (such as 128×128 pixels), with each segment serving as a basic unit for feature extraction. Alternatively, a K-means clustering algorithm can be applied to the panoramic street view image, clustering pixels based on their values (color, brightness) and spatial distribution to generate different areas, ensuring that the pixels within each area are similar and possess specific local features.

In summary, it can be understood that after the aforementioned preprocessing and segmentation operations, the processed panoramic street view image has high quality and clarity. The local segments can accurately represent the spatial elements in the image, providing reliable input data for subsequent feature extraction and the classification model.

After preprocessing the panoramic street view image, step S2 is performed as follows: extracting, based on edge detection, color analysis and texture analysis, shallow features from the panoramic street view image, and preliminarily identifying, by combining predefined shallow feature templates, spatial elements in the panoramic street view image. And step S3 is performed as follows: obtaining deep features for each of the spatial elements through a deep learning model, where the deep features include a geometric shape and a spatial position of each of the spatial elements, and semantic association relationships between different spatial elements.

Among them, the edge detection, the color analysis, and the texture analysis are first performed on the panoramic street view image to extract the shallow features. The shallow features are mainly basic visual information related to objects extracted from the pixel level of the panoramic street view image, including edges, colors, textures, etc. These shallow features can reflect the contours and local structural information of objects in the image and are an important basis for the subsequent classification of the spatial elements.

Specifically, by detecting areas with abrupt changes in grayscale values, contour information reflecting boundaries and shapes of the objects is extracted. In some embodiments of the disclosure, the Canny algorithm is used to identify areas with the greatest grayscale changes by calculating the gradient magnitude and direction of each pixel. Non-maximum suppression is applied to retain the local extrema of edges, and the edges are connected using double threshold segmentation (high and low thresholds), thereby extracting the edges of object elements in the image.

Taking the above example, after applying the Canny edge detection to the panoramic street view image of the commercial street, the contours of buildings, streetlight poles, traffic light poles, and road boundaries are successfully extracted. The edge detection results are visually clear and less affected by noise.

By extracting color distribution features, the color information of the objects in the panoramic street view image is described, providing support for classification. In some embodiments of the disclosure, the image is converted from the red-green-blue (RGB) color space to the HSV color space, separating the hue (H), saturation(S), and value (V) of the image. The HSV space is more in line with human perception of color and is convenient for processing. Subsequently, the color histograms of various areas in the image are calculated to statistically analyze the distribution of different color components. Regarding the histogram dimensions, each channel can be divided into 256 gray levels. Sliding window technology is then used to extract the color distribution features of local areas.

For example, by conducting HSV analysis on a green belt area in a street view, the main hue of the plant area (green) is identified, and differences in saturation and value of different types of plants are quantified through histograms.

By analyzing local pixel arrangement patterns in the image, texture features that reflect the roughness and structural complexity of object surfaces are extracted. In some embodiments of the disclosure, the gray-level co-occurrence matrix (GLCM) is used to statistically analyze the spatial relationships of gray-level value pairs in the image. For example, in the texture analysis of road areas in the panoramic street view image, it is found through the GLCM that the road surface texture has high uniformity (high homogeneity), while the sidewalk texture has high contrast (brick structure).

In summary, it can be understood that, for the acquired panoramic street view image, after the noise removal and enhancement operations, the edge detection, the color analysis, and the texture analysis are performed to extract the contours and the color distribution features of the objects such as buildings, vegetation, roads, streetlights, traffic lights, motor vehicles, and non-motor vehicles, and to extract the texture patterns of surfaces like building facades and road surfaces.

Through above steps, the shallow features that reflect the contours, colors, and local structures of the objects in the panoramic street view image are obtained, laying the foundation for subsequent feature registration and classification based on topological analysis.

After extracting the shallow features, deep features of the panoramic street view image are extracted based on a semantic segmentation model. The deep features represent high-level semantic information in the image and usually include: the geometric shape and the spatial position, and the contextual relationships;

The geometric shape is an overall contour and three-dimensional structural information of an object, such as the shape of buildings and the outline of motor vehicles.

The spatial position is a specific position of the object in the image and the relative positional relationships between the object and other objects.

The contextual relationships are semantic connections between the object and its surrounding environment, such as the relationship between traffic lights and roads, and between buildings and crowds.

The deep features are automatically learned from data through the deep learning model, which typically relies on the convolutional neural network (CNN) and its extended architecture, such as the semantic segmentation model, for the extraction of the deep features. Commonly used semantic segmentation model architectures include, but are not limited to, U-Net, DeepLabv3+, and PSP Net.

It can be understood that the geometric shape, the spatial location and the contextual relationships of the deep features provide the input for the classification model in subsequent topological analysis and logical rule registration.

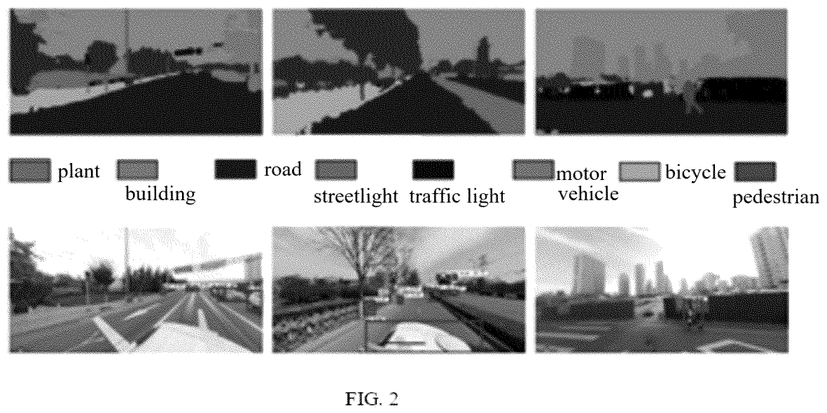

A following table, referring to FIG. 2, integrates the target spatial elements of the high-intensity urban areas with the shallow features, the deep features, and predefined logical rules.

| Spatial | | | |
|---|---|---|---|
| element | Shallow feature | Deep feature | Logical rule |
| Building | Edge detection: straight | Geometric shape: rectangular or | Buildings should be |
| | or rectangular edges; | polygonal contours; spatial | parallel and adjacent to |
| | color analysis: | position: occupying top and | roads; and maintain an |
| | predominantly grayish- | middle areas of the image; | appropriate distance from |
| | white or light colors; | contextual relationship: adjacent | streetlights. |
| | texture analysis: regular | to roads or vegetation. | |
| | parallel textures. | | |
| Vegetation | Edge detection: irregular | Geometric shape: irregular and | Vegetation should be |
| | curved edges; color | fragmented shapes; spatial | located between buildings |
| | analysis: predominantly | position: along roadsides or next | and roads; its shape and |
| | green; texture analysis: | to buildings; contextual | position should conform to |
| | dense, fine textures. | relationship: adjacent to | the characteristics of green |
| | | buildings and roads. | belts or street trees; |
| | | | vegetation should not |
| | | | appear in the middle of |
| | | | motor vehicle lanes or non- |
| | | | motor vehicle lanes. |
| Road | Edge detection: smooth | Geometric shape: linear, | Roads should be elongated |
| | straight lines or curves; | elongated distribution; spatial | and adjacent to buildings; |
| | color analysis: grayish- | position: spanning the bottom of | motor vehicles should |
| | black or dark colors; | the image; contextual | primarily be distributed in |
| | texture analysis: | relationship: adjacent to | road areas; vegetation or |
| | continuous, smooth | buildings and motor vehicles. | streetlights should appear |
| | textures. | | at the edges of roads. |
| Streetlight | Edge detection: smooth | Geometric shape: cylindrical | Streetlights should be |
| | straight lines; color | poles; spatial position: close to | evenly distributed on both |
| | analysis: gray or metallic | edges of roads; contextual | sides of the road; maintain |
| | colors; texture analysis: | relationship: parallel to roads, | an appropriate distance |
| | smooth, regularly | distributed next to buildings. | from buildings, and should |
| | distributed. | | not appear in the middle of |
| | | | roads; the spacing of |
| | | | streetlights should conform |
| | | | to the statistical |
| | | | distribution of urban |
| | | | planning. |
| Traffic | Edge detection: dot-like | Geometric shape: combinations | Traffic lights should appear |
| light | or rectangular edges; | of small rectangular blocks; | at intersections or the |
| | color analysis: high- | spatial position: at intersections | beginning of roads; |
| | contrast red, yellow, and | or the ends of roads; contextual | adjacent to streetlights, |
| | green colors; texture | relationship: close to | should not be suspended |
| | analysis: smooth with no | streetlights, adjacent to roads. | alone; conform to the |
| | distinct textures. | | statistical patterns of traffic |
| | | | facility distribution. |
| Motor | Edge detection: regular | Geometric shape: rectangular or | Motor vehicles should |
| vehicle | rectangular or curved | streamlined contours; spatial | appear in road areas; the |
| | contours; color analysis: | position: concentrated in road | quantity should conform to |
| | diverse; texture analysis: | areas; contextual relationship: | the lane density |
| | smooth surfaces with | maintain a certain distance from | distribution. |
| | regularly distributed local | non-motor vehicles and | |
| | features. | pedestrians. | |
| Non- | Edge detection: small | Geometric shape: relatively | Non-motor vehicles should |
| motor | rectangular or curved | small rectangular or curved | be concentrated in non- |
| vehicle | contours; color analysis: | features; spatial position: | motor vehicle lanes or at |
| | diverse; texture analysis: | concentrated in non-motor | the edges of roads. |
| | relatively simple surface | vehicle lanes or at edges of | |
| | features. | roads; contextual relationship: | |
| | | close to roads or sidewalks. | |
| Pedestrian | Edge detection: thin | Geometric shape: small vertical | Pedestrians should be |
| | vertical edges; color | rectangles; spatial position: | concentrated at the edges |
| | analysis: diverse; texture | concentrated at edges of roads | of roads or in sidewalk |
| | analysis: complex local | or in sidewalk areas; contextual | areas; conform to the |
| | features. | relationship: adjacent to non- | statistical patterns of |
| | | motor vehicles and vegetation. | pedestrian distribution. |

Step S4 is performed as follows: constructing, based on topological analysis, a topological graph of the spatial elements, and optimizing, according to predefined logical rules, a topological structure of the topological graph to obtain an optimized topological graph, where each of nodes in the topological graph represents a corresponding one of the spatial elements and carries the shallow features and the deep features of the corresponding one of the spatial elements, edges between the nodes represent the semantic association relationships between the spatial elements respectively.

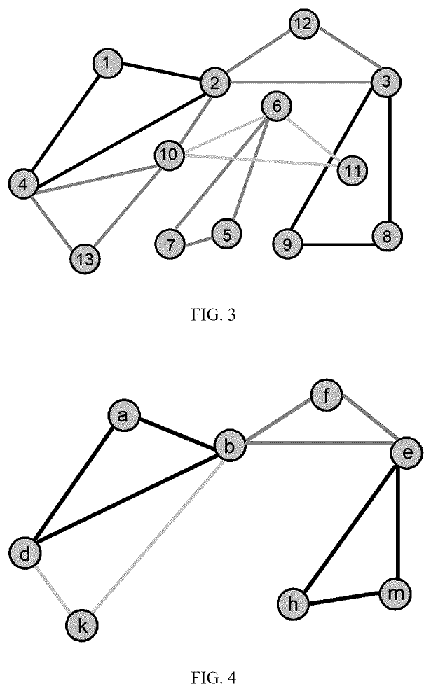

Specifically, the topological graph is first constructed, each node represents an object element in the panoramic street view image. Referring to FIGS. 3-4. It should be noted that types of object elements are more numerous than types of target spatial elements to be identified. Nodes include the shallow features of objects (such as edges, colors, textures, etc.) and the deep features (geometric shapes, spatial positions and contextual relationships), which are represented through specific data structures.

The edges between the nodes represent the spatial relationships between the object elements, and the edge weights reflect the strength of the topological relationships, calculated based on the following identified features: the spatial position, color similarity and semantic relevance.

The spatial position is the distance between adjacent object elements (e.g., the shortest distance between a building and a road);

The color similarity is the closeness of colors assessed by the color space distance (e.g., in the HSV or Lab space);

The semantic relevance is obtained from the semantic matching of object categories by the semantic segmentation model, for example, buildings are usually adjacent to roads, and streetlights are typically close to roads.

In addition, in some embodiments of the disclosure, the relative distances between different spatial elements can also be calculated. The relative distance usually refers to the geometric distance between different spatial elements or the distance under a certain measurement standard. The deep learning semantic segmentation model can precisely locate the position of each spatial element and further calculate the relative distances between them.

For example, if there is a clear gap between a building and a road in the image, or if there is a specific layout relationship between a building and a streetlight, the relative distance between the building and the road can be calculated by extracting the geometric information and spatial positions of the spatial elements, and can be used as an important reference in the topological analysis.

In summary, after extracting the shallow and deep features of the spatial elements to construct the nodes of the topological graph, the predefined logical rules are used to define the connection relationships between the spatial elements in the topological graph and to optimize the structure of the topological graph. Specifically, the core of the predefined logical rules is to adjust the weights of the edges between the nodes in the topological graph based on the geometric shapes, spatial positions, relative distances, and semantic association relationships of the spatial elements. The following summarized logical rules can be referred to the table mentioned above.

Firstly, projection distances between the different spatial elements are calculated based on the geometric shapes and spatial positions of the spatial elements extracted by the deep learning model, the projection distance refers to the distance between two spatial element objects on a plane, usually considering the distance between the closest edges or center points of the two objects.

After obtaining the projection distances between the spatial elements, in some embodiments, a distance threshold is considered to be set to control whether to adjust the weights of the edges. For example, if the projection distance between two spatial elements is less than the distance threshold, it indicates a strong spatial association between the two spatial elements, and the weight of the edge between the two spatial elements will be increased. Conversely, if the distance is greater, it indicates a weaker association between the two spatial elements, and the corresponding weight of the edge between the two spatial elements will be reduced.

In addition to spatial positions, the semantic association relationships between the spatial elements are also an important factor in adjusting edge weights. The semantic association relationships refer to the functional connections between different spatial elements in the real environment. For example, as shown in the table above, buildings and roads usually have a close semantic association because buildings are typically distributed along roads, and roads provide transportation access to buildings. Streetlights and roads also have a semantic association because streetlights are generally installed on two sides of a road to provide nighttime illumination.

For the spatial elements with functional associations, the weights of their connecting edges should be increased. For the spatial elements without functional associations, such as between buildings and streetlights, if there is no direct functional connection, the edge between these two spatial elements should be removed. Referring to FIGS. 3-4, the initial topological graph has 13 nodes representing different spatial elements, such as buildings, roads, green lands, and streetlights. The optimization goal is to adjust the edge weights and remove the edges between the nodes that do not have functional associations, thereby streamlining the graph structure and enhancing the practical significance and classification efficiency of the topological graph.

It is assumed the initial topological graph is as following table.

| | |
|---|---|
| Node 1 | Building |
| Node 2 | Road |
| Node 3 | Parking lot |
| Node 4 | Road |
| Node 5 | Building |
| Node 6 | Sidewalk |
| Node 7 | Billboard |
| Node 8 | Square |
| Node 9 | Bus stop |
| Node 10 | Pool |
| Node 11 | Pool |
| Node 12 | Streetlight |
| Node 13 | Green land |

During the optimization process of the topological graph, functional contextual relationships are assessed as follows.

There is a functional association between buildings and roads, and buildings require roads for transportation connections, so the edges are retained.

Typically, there is no direct functional association between buildings and streetlights (unless in special cases, such as when building illumination depends on streetlights), so the edges should be removed.

Roads and parking lots have a functional association, and parking lots need to be connected to roads, so the edges are retained.

Streetlights and squares have a functional association (streetlights usually illuminate squares), so the edges are retained.

Bus stops and roads have a functional association, and bus stops are usually located beside roads, so the edges are retained.

The nodes of the optimized topological graph are as following table.

| | |
|---|---|
| Node a | Building |
| Node b | Road |
| Node d | Road |
| Node k | Green land |
| Node f | Streetlight |
| Node e | Parking lot |
| Node h | Bus stop |
| Node m | Square |

In some embodiments of the disclosure, the weight adjusting can also be guide by constructing a rule set in advance. For example, the rule set assigns high weights to connections between buildings, roads, and streetlights, while connections between vehicles and streetlights lack significant functional associations, and thus their weights are zero or low.

It can be understood that, under the predefined logical rules, the weights of the edges in the topological graph are adjusted to reflect real relationships between the spatial elements. On this basis, the graph convolutional network (GCN) operation is performed to further optimize the node features and spatial distribution in the topological graph. The GCN operation updates the node features for each node by weighted aggregating the features of its neighboring nodes, enhancing the representation ability of the topological graph, especially for spatial element relationships in the large-scale high-intensity urban area.

Specifically, the weights of the edges are updated based on the feature correlations of neighboring nodes, such that edges with stronger semantic and spatial correlations are assigned higher weights. The update formula is as follows:

$${h}_{i}^{( l + 1 )} = σ ( {\sum }_{j ∈ N ( i )} \frac{1}{\sqrt{{d}_{i} {d}_{j}}} {W}^{( l )} {h}_{i}^{l} + {W}^{( l )} {h}_{j}^{l} )$$

where

$${h}_{i}^{l}$$

represents a feature vector of an i-th node of the nodes at an l-th layer, N(i) represents a set of neighboring nodes of the i-th node, W^{(l)} represents a learnable weight matrix of a graph convolutional layer, dᵢ represents a degree of the i-th node, dⱼ represents a degree of a j-th node of the nodes, and σ represents a non-linear activation function, such as rectified linear function (ReLU).

For the i-th node, the features are updated by aggregating the features of its neighboring nodes N (i). The aggregation methods typically include weighted averages, weighted sums, etc. The weight of each edge affects the degree of aggregation of the features of neighboring nodes. Edges with higher weights have a greater influence on the features of neighboring nodes, while edges with lower weights reduce the influence of the features of neighboring nodes. Based on aggregated results, combined with the original node features, the node features are updated through the nonlinear activation function. The updated node features can better capture the mutual relationships and topological structures between the spatial elements.

The results of graph convolution update the node features in the topological graph, thereby optimizing the structure of the topological graph. Specifically, after the graph convolution operation, the updated node features can make the topological graph more consistent with the actual spatial relationships. For example, the connections between the spatial elements such as buildings, roads, and streetlights become clearer. The adjustment and update of edge weights ensure that the actual semantic associations between these spatial elements are properly reflected.

The optimized topological graph obtained through graph convolution can provide more accurate input features for subsequent classification tasks, helping the classification model to better identify the spatial elements and generate accurate spatial distribution maps.

In summary, it can be understood that, by adjusting the weights of the edges based on the geometric shapes, spatial locations, semantic associations, etc., and optimizing the topological graph through the graph convolution operation, the modeling of mutual relationships between the spatial elements can be effectively improved, which ensures that the topological graph accurately reflects the spatial structure in the actual scene. The optimized topological graph not only improves the classification accuracy of spatial elements but also enhances the interpretability and consistency of the classification results, providing strong support for subsequent urban street scene analysis and spatial element distribution prediction.

Finally, step S5 is performed as follows: inputting the optimized topological graph into a pre-trained classification model, and outputting, by the pre-trained classification model, classification results and a spatial distribution image of the spatial elements in the panoramic street view image based on node features and a topological structure of the optimized topological graph. The core purpose of this step is to utilize the pre-trained classification model, which learns the relationships between the node features and the topological structure, combines feature space and contextual semantic information of the spatial elements to classify each node, and ultimately outputs the category labels of each spatial element in the panoramic street view image and their spatial distribution within the image.

The pre-trained classification model, by combining deep learning techniques and topological graph information, can perform efficient classification based on the shallow and deep features of the spatial elements. Through multi-layer neural networks and the message-passing mechanism, the classification model can accurately identify and classify the spatial elements in the panoramic street view image and generate the spatial distribution image of the spatial elements.

For a training process of the classification model, it is started with inputting the topological graph, the deep learning-based classification model extracts the feature vector of each node from the original spatial element description. This feature vector, acting as representation of each node, is fed into the classification model.

Specifically, referring to the aforementioned graph neural network, the adjacency relationships and node features in the graph structure are used to aggregate information layer by layer. The output of each layer updates the node features, and during message passing, the weights of the edges are used to adjust the contribution of neighboring nodes to the target node, integrating information from shallow to deep semantics.

Subsequently, the feature vector of each node is input into a defined classifier. The classifier determines the category of the spatial elements according to the feature vector of each node, uses a fully connected layer and the Softmax function to output the probability distribution of the category of each node, thereby outputting the category label of each node.

Once the classification results of all nodes are output, the pre-trained classification model combines the category labels with spatial positional relationships to generate the spatial distribution image of the spatial elements in the panoramic street view image. The spatial distribution image not only reflects the categories of the spatial elements, but also shows their geographic distribution.

In conclusion, it can be understood that through the classification model based on deep learning, by combining the node features and adjacency relationships in the topological graph, the classification of the spatial elements can not only accurately identify individual elements but also perform efficient classification according to the spatial position and contextual information. During this process, the message-passing mechanism and feature fusion technology can effectively capture the interrelationships among the spatial elements. Ultimately, a more accurate spatial distribution image is output. This method not only improves the classification accuracy but also enhances the spatial consistency and interpretability of the classification results, providing strong technical support for urban street view analysis.

The above description is only the exemplary embodiment of the disclosure and does not limit the disclosure. The scope of patent protection of the disclosure shall be subject to the claims. Any equivalent structural changes made using the description and drawings of the disclosure shall also be included in the scope of protection of the disclosure.

1. A quantitative analysis method for spatial elements in urban areas based on image data, comprising:
obtaining a panoramic street view image from observation points in a selected urban area;
extracting, based on edge detection, color analysis and texture analysis, shallow features from the panoramic street view image, and preliminarily identifying, by combining predefined shallow feature templates, spatial elements in the panoramic street view image;
obtaining deep features for each of the spatial elements through a deep learning model, wherein the deep features comprise a geometric shape and a spatial position of each of the spatial elements, and semantic association relationships between the spatial elements;
constructing, based on topological analysis, a topological graph of the spatial elements, and optimizing, according to predefined logical rules, a topological structure of the topological graph to obtain an optimized topological graph, wherein each of nodes in the topological graph represents a corresponding one of the spatial elements and carries the shallow features and the deep features of the corresponding one of the spatial elements, edges between the nodes represent the semantic association relationships between the spatial elements respectively; and
inputting the optimized topological graph into a pre-trained classification model, and outputting, by the pre-trained classification model, classification results and a spatial distribution image of the spatial elements in the panoramic street view image based on node features and a topological structure of the optimized topological graph;
wherein the predefined logical rules comprise:
adjusting, based on the geometric shape and the spatial position of each of the spatial elements and relative distances between the spatial elements, a weight of each of the edges, comprising:
calculating projection distances between the spatial elements, setting a distance threshold, and adjusting the weight of each of the edges proportionally; and
adjusting, based on the semantic association relationships between the spatial elements, the weight of each of the edges, comprising:
in response to two of the spatial elements having a functional association in a real scene, increasing a weight of an edge between nodes represented by the two of the spatial elements; and
in response to two of the spatial elements having no functional association, deleting the edge between the nodes represented by the two of the spatial elements.

2. The quantitative analysis method for spatial elements in urban areas based on the image data as claimed in claim 1, before the extracting, based on edge detection, color analysis and texture analysis, shallow features from the panoramic street view image, the quantitative analysis method comprising:
performing image preprocessing on the panoramic street view image, wherein the image preprocessing comprises: noise removal, image enhancement, and image segmentation, comprising:
removing random noise from the panoramic street view image, and preserving edge information in the panoramic street view image to obtain a noise-removed panoramic street view image; and
performing brightness and contrast analysis on the noise-removed panoramic street view image, performing histogram equalization on local areas of the noise-removed panoramic street view image, and performing contrast enhancement on a target area of the noise-removed panoramic street view image.

3. The quantitative analysis method for spatial elements in urban areas based on the image data as claimed in claim 1, wherein the extracting, based on edge detection, color analysis and texture analysis, shallow features from the panoramic street view image comprises:
performing Canny edge detection on the panoramic street view image, comprising: locating, by calculating a grayscale change intensity and using gradient information, boundaries of objects in the panoramic street view image;
extracting, through a hue-saturation-value (HSV) color space, color distribution features of each of the objects; and
extracting, by using a gray-level co-occurrence matrix, surface texture information of each of the objects.

4. The quantitative analysis method for spatial elements in urban areas based on the image data as claimed in claim 3, wherein the preliminarily identifying, by combining predefined shallow feature templates, spatial elements in the panoramic street view image comprises:
matching the objects in the panoramic street view image and the shallow features thereof with the predefined shallow feature templates to preliminarily identify the spatial elements represented by the objects respectively through a matching algorithm.

5. The quantitative analysis method for spatial elements in urban areas based on the image data as claimed in claim 1, wherein the obtaining deep features for each of the spatial elements through a deep learning model comprises:
obtaining, through a deep learning-based semantic segmentation model, the deep features for each of the spatial elements, wherein the deep features comprise the relative distances between the spatial elements.

6. (canceled)

7. The quantitative analysis method for spatial elements in urban areas based on the image data as claimed in claim 1, wherein the optimizing, according to predefined logical rules, a topological structure of the topological graph to obtain an optimized topological graph comprises:
updating, according to the predefined logical rules, the weight of each of the edges, and performing a graph convolution operation to optimize the node features and spatial distribution in the topological graph.

8. The quantitative analysis method for spatial elements in urban areas based on the image data as claimed in claim 1, wherein the pre-trained classification model is configured to perform classification on the spatial elements in the panoramic street view image based on a deep learning technology, and a training process of the pre-trained classification model comprises:
inputting the optimized topological graph, and generating a feature vector corresponding to each of the nodes based on the shallow features and the deep features of each of the nodes;
aggregating, through a message-passing mechanism and according to adjacency relationships and weights of edges corresponding to a target node to be recognized, features of neighboring nodes of the target node to obtain aggregated features of the neighboring nodes, and fusing the aggregated features of the neighboring nodes with current features of the target node to generate target node features comprising contextual information; and
inputting the feature vector corresponding to each of the nodes to a defined classifier to output the classification result for each of the spatial elements, and generate the spatial distribution image for the spatial elements in the panoramic street view image by combining the classification results of the spatial elements and spatial position relationships in the optimized topological graph.
